(19) United States
(12) Patent Application Publication
(10) Pub. No.: US 2006/0208108 A1
(43) Pub. Date: Sep. 21, 2006

(54) Fuel injection valve

(75) Inventors: Noritsugu Kato, Okazaki-city (JP); Hitoshi Shibata, Okazaki-city (JP); Terutoshi Tomoda, Mishima-city (KR); Tomihisa Tsuchiya, Toyota-city (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); TOYOTA JIDOSHA KABUSHIKI KAISHA, Toyota-city (JP)

(21) Appl. No.: 11/377,643

(22) Filed: Mar. 17, 2006

(30) Foreign Application Priority Data
Mar. 18, 2005 (JP) 2005-78456

(51) Int. Cl. F02M 43/00; F02M 51/00

(52) U.S. Cl. 239/533.3; 239/585.1

(57) ABSTRACT

A relationship between an inner diameter A of a sac volume and a distance from a central axis of the sac volume is set to satisfy a condition of 1≦A/2B≦20. In this way, fuel, which flows from the sac volume into each injection hole, will be injected from the injection hole without being spaced from a wall surface of a valve body, which form the injection hole. Thus, it is possible to limit adhesion of a foreign substance to a wall surface of each injection hole. Furthermore, even if the foreign substance is adhered to the wall surface of the injection hole, the foreign substance can be removed by the fuel, which flows through the injection hole.

### CROSS REFERENCE TO RELATED APPLICATION

This application is based on and incorporates herein by reference Japanese Patent Application No. 2005-78456 filed on Mar. 18, 2005.

### BACKGROUND OF THE INVENTION

1. Field of the Invention

The present invention relates to a fuel injection valve used in, for example, an internal combustion engine.

2. Description of Related Art

In a previously known fuel injection valve, a fuel passage is opened and closed by an axially reciprocable valve member to start and stop fuel injection from injection holes (see, for example, Japanese Unexamined Patent Publication No. 2000-314359). In the fuel injection valve recited in Japanese Unexamined Patent Publication No. 2000-314359, a sac volume, to which the injection holes are opened, is provided on the downstream side of a valve seat in a fuel flow direction. In this way, when the valve member is lifted away from the valve seat, the fuel in the fuel passage is injected from the injection holes through the sac volume.

However, in the case of the fuel injection valve recited in Japanese Unexamined Patent Publication No. 2000-314359, the fuel flow, which is supplied into each injection hole, is sometimes spaced away from a wall surface of a valve body, which forms the injection hole. When the fuel flow is spaced away from the wall surface of the valve body, a portion of the wall surface of the valve body does contact the fuel flow. Therefore, even in a case where a foreign object or substance is adhered to the wall surface of the valve body, the adhered foreign substance cannot be removed, i.e., washed away by the fuel flow. As a result, the foreign substance is accumulated in the interior of each injection hole, so that a spray characteristic (an injection characteristic) of fuel injected through the injection hole is disadvantageously changed with time.

### SUMMARY OF THE INVENTION

Therefore, it is an objective of the present invention to provide a fuel injection valve, which minimizes a change in a fuel injection characteristic with time for fuel injected through an injection hole.

To achieve the objective of the present invention, there is provided a fuel injection valve, which includes a valve body and a valve member. The valve body includes a valve seat, a sac volume and at least one injection hole. The valve seat is formed in an inner wall surface of the valve body, which forms a fuel passage. The sac volume is arranged on a downstream side of the valve seat in a fuel flow direction. The at least one injection hole has an upstream end, which opens to the sac volume, and a downstream end, which opens to an outer wall surface of the valve body. The valve member opens and closes the fuel passage when the valve member is lifted away from the valve seat and is seated against the valve seat, respectively. The sac volume and each injection hole satisfy a condition of 1≦A/2B≦20 where A is an inner diameter of the sac volume, and B is a distance from a central axis of the sac volume to the injection hole at the upstream end of the injection hole.

In the above injection valve, each injection hole may be formed as a slit. Also, the at least one injection hole of the valve body may include two or more injection holes. Here, the two or more injection holes may be uniformly arranged about the central axis of the sac volume. Here, the word “uniformly” means each of the two or more injection holes is arranged at a corresponding point, which is spaced a equal distance from the central axis, and a shape, a space or the like of the respective injection holes are uniform.

### BRIEF DESCRIPTION OF THE DRAWINGS

The invention, together with additional objectives, features and advantages thereof, will be best understood from the following description, the appended claims and the accompanying drawings in which:

FIG. 1 is a cross sectional view showing an area around injection holes of an injector according to a first embodiment of the present invention;

FIG. 2 is a cross sectional view showing the injector according to the first embodiment of the present invention;

FIG. 3 is a view seen in a direction of an arrow III in FIG. 1 showing the injection holes, which open to a sac volume in the injector, according to the first embodiment of the present invention;

FIG. 4 is a schematic diagram showing a relationship between A/2B and an amount of change in a spray angle;

FIG. 5 is a schematic view for describing the spray angle;

FIG. 6 is a schematic view showing flows of fuel injected from the injection holes in a case of A/2B<1;

FIG. 7 is a schematic view showing flows of fuel v2 injected from the injection holes in a case of 20<A/2B;

FIG. 8 is a schematic view showing flows of fuel V injected from the injection holes in a case of 1≦A/2B≦20; and

FIG. 9 is a view similar to that of FIG. 3, showing injection holes, which open to a sac volume in an injector, according to a second embodiment of the present invention.

### DETAILED DESCRIPTION OF THE INVENTION

Various embodiments of the present invention will be described with reference to the accompanying drawings.

### First Embodiment

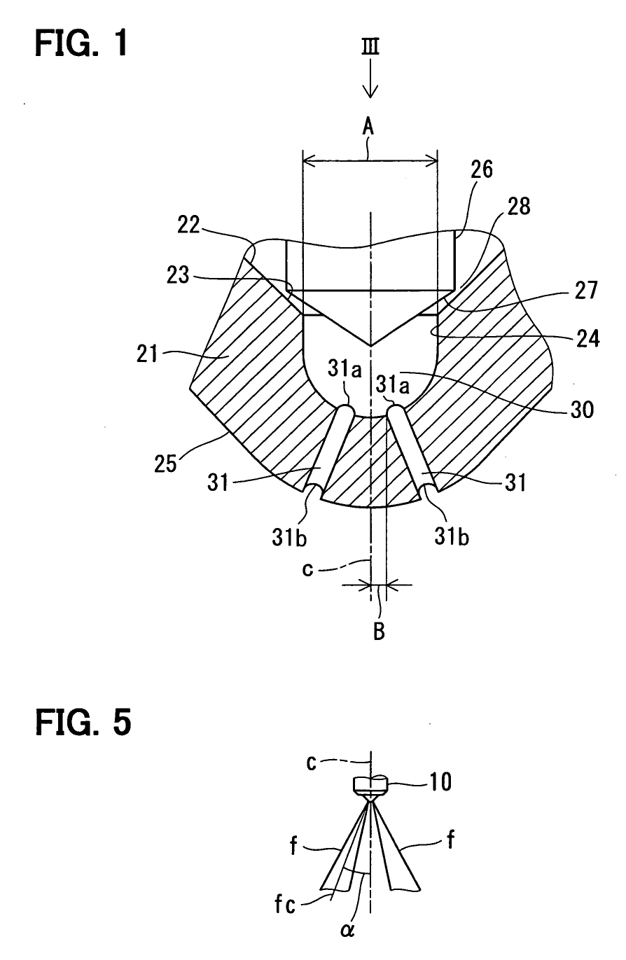

FIGS. 1 to 3 show a fuel injection valve (hereinafter, referred to as “injector”) according to a first embodiment of the present invention. The injector 10 of the first embodiment is applied in, for example, a gasoline engine of a direct injection type. However, it should be noted that the application of the injector 10 is not limited to the gasoline engine of the direct injection type, and the injector 10 may be applied in a gasoline engine of a port injection type or a diesel engine. In the case of applying the injector 10 in the gasoline engine of the direct injection type, the injector 10 is installed in a cylinder head of the engine. A pressure P of fuel, which is injected from the injector 10, is set to be in a range of 0<P≦30 MPa. In the case of applying the injector 10 in the gasoline engine of the direct injection type like in the present embodiment, the pressure of the fuel, which is injected from the injector 10, is about 10 MPa.

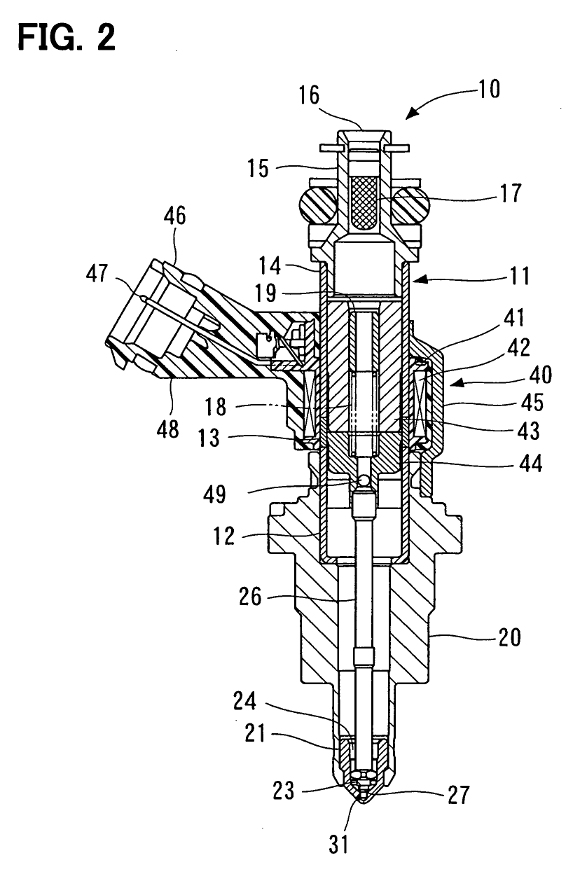

With reference to FIG. 2, a housing 11 of the injector 10 is formed into a tubular body. The housing 11 includes a first magnetic part 12, a non-magnetic part 13 and a second magnetic part 14. The non-magnetic part 13 limits magnetic short circuiting between the first magnetic part 12 and the second magnetic part 14. The first magnetic part 12, the non-magnetic part 13 and the second magnetic part 14 are integrally joined together by, for example, laser welding. In place of the above manufacturing process of the housing 11, the housing 11 may be molded integrally into a single tubular body from a magnetic material or a non-magnetic material. In the case of molding the tubular body from the magnetic material, the molded tubular body may be processed through a heating step to demagnetize a portion of the tubular body, which corresponds to the non-magnetic part 13. Alternatively, in the case of molding the tubular body from the non-magnetic material, portions of the molded tubular body, which correspond to the first and second magnetic parts 12, 14, may be magnetized.

An inlet member 15 is arranged in an upstream end portion of the housing 11. The inlet member 15 is press fitted to an inner peripheral wall of the housing 11. The inlet member 15 forms a fuel inlet 16. Fuel is supplied from a fuel tank (not shown) to the fuel inlet 16 via a pump (not shown). The fuel, which is supplied to the fuel inlet 16, flows into an interior of the housing 11 through a filter member 17. The filter member 17 removes foreign objects or foreign substances contained in the fuel.

A holder 20 is provided to a downstream end portion of the housing 11. The holder 20 is formed into a tubular body and receives a valve body 21 therein. The valve body 21 is formed into a tubular body and is fixed to an inner wall of the holder 20 by, for example, press fitting or welding. As shown in FIG. 1, the valve body 21 has a conical inner wall surface 22, which is tapered toward a downstream end of the valve body 21 to have a decreasing inner diameter toward the downstream end of the valve body 21, and a valve seat 23 is provided in the inner wall surface 22. The valve body 21 has a sac volume (also referred to as a sac chamber) 30. The sac volume 30 is connected to a downstream side of the inner wall surface 22, which is opposite from the housing 11. An upstream end 31a of each of injection holes 31 opens to the sac volume 30. Specifically, the upstream end 31a of each injection hole 31 opens to an inner wall surface 24 of the valve body 21 (i.e., an inner wall surface of the sac volume 30), which forms the sac volume 30, and a downstream end 31b of the injection hole 31 opens to an outer wall surface 25 of the valve body 21.

As shown in FIG. 2, a needle 26, which serves as a valve member, is axially reciprocably received in the housing 11, the holder 20 and the valve body 21. The needle 26 is generally coaxial with the valve body 21. The needle 26 has a sealing part 27 at a downstream end portion of the needle 26, which is opposite from the fuel inlet 16. The sealing part 27 is seatable against the valve seat 23 of the valve body 21. As shown in FIG. 1, a fuel passage 28 for conducting fuel is formed between the inner wall surface 22 of the valve body 21 and the outer peripheral wall surface of the needle 26, in which the sealing part 27 is formed.

As shown in FIG. 2, the injector 10 further includes a drive arrangement 40 for driving the needle 26. The drive arrangement 40 is an electromagnetic drive arrangement that electromagnetically drives the needle 26. The drive arrangement 40 includes a spool 41, a coil 42, a stationary core 43, a movable core 44 and a plate housing 45. The spool 41 is arranged radially outward of the housing 11. The spool 41 is made of resin and is shaped into a tubular body. Furthermore, the coil 42 is wound around the spool 41. The coil 42 is electrically connected to terminals 47 of a connector 46. The stationary core 43 is arranged radially inward of the coil 42 in such a manner that the housing 11 is placed between the stationary core 43 and the coil 42. The stationary core 43 is made of a magnetic material, such as iron, and is shaped into a tubular body. Furthermore, the stationary core 43 is fixed to the inner peripheral wall of the housing 11 by, for example, press fitting. The plate housing 45 is made of a magnetic material and covers an outer peripheral part of the coil 42. The plate housing 45 magnetically connects between the second magnetic part 14 of the housing 11 and the holder 20. The spool 41 and the outer peripheral part of the coil 42 are covered with a resin mold 48 that integrally forms the connector 46.

The movable core 44 is axially reciprocably received in the housing 11. The movable core 44 is made of a magnetic material, such as iron, and is shaped into a tubular body. A downstream end portion of the movable core 44, which is opposite from the stationary core 43, is integrally connected to the needle 26. An upstream end portion of the needle 26, which is opposite from the sealing part 27, is fixed to the movable core 44. In this way, the movable core 44 and the needle 26 are integrally axially reciprocated.

An upstream end portion of the movable core 44, which is located on a side where the stationary core 43 is arranged, contacts a spring 18, which serves as a resilient member. A downstream end portion of the spring 18 contacts the movable core 44, and an upstream end portion of the spring 18 contacts an adjusting pipe 19. The resilient member is not limited to the spring 18 and can be a leaf spring or an air or liquid damper. The adjusting pipe 19 is press fitted into the stationary core 43. A load of the spring 18 is adjusted by adjusting an amount of insertion of the adjusting pipe 19 into the stationary core 43. The spring 18 has a resilient force to axially expand. Therefore, the needle 26 and the movable core 44, which are formed integrally, are urged by the spring 18 in a seating direction for seating the sealing part 27 against the valve seat 23.

When the coil 42 is not energized, the sealing part 27 is seated against the valve seat 23 by the urging force of the spring 18. Furthermore, when the coil 42 is not energized, a predetermined space is present between the stationary core 43 and the movable core 44. When the coil 42 is energized, the movable core 44 is magnetically attracted toward the stationary core 43, so that opposed surfaces of the stationary core 43 and of the movable core 44 contact with each other. In this way, the movement of the movable core 44 and the needle 26 toward the stationary core 43 is limited.

Next, the valve body 21 will be described in greater detail.

As shown in FIG. 1, the valve body 21 has the valve seat 23 in the inner wall surface 22. The sealing part 27 of the needle 26 is seatable against the valve seat 23. The sac volume 30 is connected to the downstream end portion of the inner wall surface 22, which is on the downstream side in the fuel flow direction, i.e., which is opposite from the housing 11. The sac volume 30 is formed by the inner wall surface 24 of the valve body 21. The sac volume 30 is shaped into a cylindrical form and has a generally semispherical surface at a downstream end of the sac volume 30, which is opposite from the inner wall surface 22.

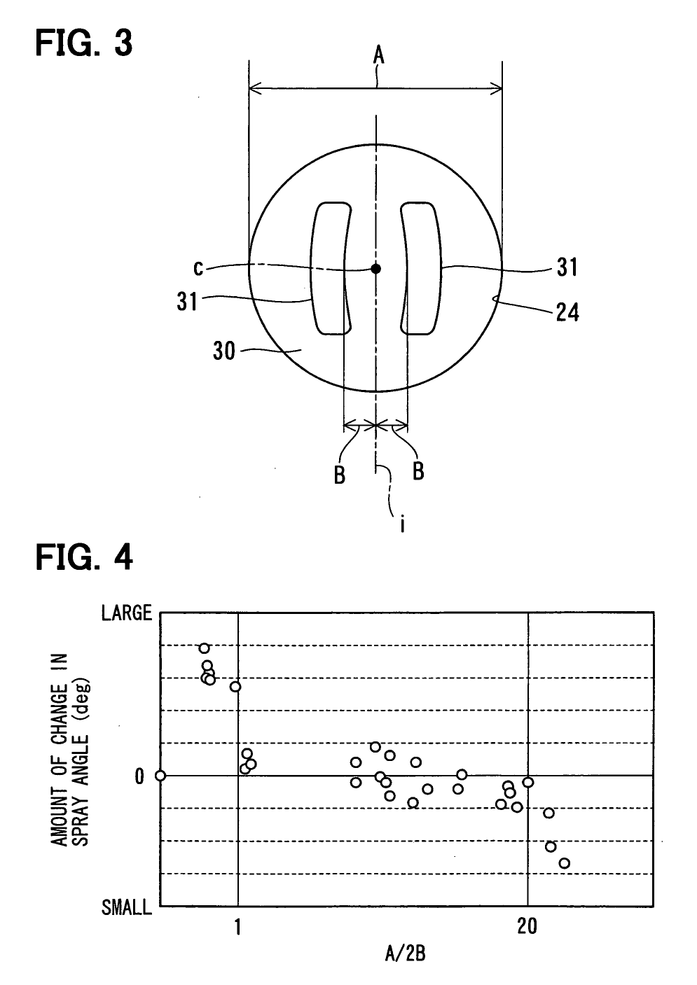

A fuel inlet (i.e., the upstream end 31a) of each injection hole 31 opens to the inner wall surface 24 of the valve body 21, which forms the sac volume 30. The opposite end of the injection hole 31, which is opposite from the sac volume 30, opens in the outer wall surface 25 of the valve body 21. In this way, the injection hole 31 penetrates through the valve body 21 and communicates between the sac volume 30 and the outer wall surface 25. The injection hole 31 forms a predetermined angle relative to a central axis of the valve body 21, i.e., a central axis c of the sac volume 30. As shown in FIG. 3, the injection holes 31 are arranged around the central axis c of the sac volume 30. In the present embodiment, the number of the injection holes 31 provided in the valve body 21 is two. The injection holes 31 are uniformly arranged about the central axis c. In the case of the present embodiment, a distance from the central axis c to each of the injection holes 31 is generally constant. In addition, the two injection holes 31 are formed to have generally an identical shape. Furthermore, the two injection holes 31 are arranged symmetrically about an imaginary straight line i, which crosses the central axis c in a direction perpendicular to the central axis c. Here, the imaginary straight line i serves as a symmetry axis. Each injection hole 31 is shaped into or is formed as a slit. More specifically, a cross section of each injection hole 31 in a plane perpendicular to an axis of the injection hole 31 is generally flattened or is elongated to have a generally rectangular shape or slightly arcuated shape. With the above construction, fuel, which is injected from each injection hole 31, forms a fuel spray configuration that is like a liquid film.

A relationship between the sac volume 30 and the injection holes 31 is as follow.

With reference to FIG. 1, an inner diameter of the sac volume 30 is denoted as “A”, and a distance from the central axis c of the sac volume 30 to each injection hole 31 is denoted as “B”. In such a case, the inner diameter A and the distance B satisfy the relationship of 1≦A/2B≦20. The distance B from the central axis c of the sac volume 30 to the injection hole 31 referrers to a distance from the central axis c to the inner wall surface of the injection hole 31, i.e., to a central axis c side end (or a radially innermost point) of the injection hole 31. The inner diameter of the sac volume 30 is set to be generally in, for example, a range of 0.5 mm to 2.0 mm.

Now, the reason for setting the relationship between the inner diameter A and the distance B to 1≦A/2B≦20 will be described. As shown in FIG. 4, a change in a characteristic of the fuel spray injected from the injector 10 is measured while the value of A/2B is changed. In FIG. 4, a change in an angle of the fuel spray (hereinafter, referred to as a spray angle) is measured as the change in the characteristic of the fuel spray (the characteristic of fuel injection, i.e., the fuel injection characteristic). The spray angle is an angle a that is formed between a center (or a central axis) fc of the spray f, which is injected from the injection hole 31 of the injector 10, and the central axis of the injector 10, i.e., the central axis c of the sac volume 30, as shown in FIG. 5. In the exemplary case of FIG. 4, the inner diameter of the sac volume 30 is set to be 0.9 mm. The spray angle a changes when a foreign object or substance adheres to the injection hole 31 upon repeated fuel injections from the injection hole 31. Thus, in the case of FIG. 4, the experiment is performed in such a manner that the injectors 10, which have different values of A/2B, are used, and fuel injection is repeated for a predetermined time period. FIG. 4 shows a difference between the spray angle at the time of beginning of the experiment and the spray angle after the end of the experiment. In FIG. 4, when the amount of change in the spray angle is zero, there is no change in the spray angle before and after the fuel injections. Furthermore, when the amount of change in the spray angle is greater than zero, it means that the spray angle is increased after the injection experiment. Alternatively, when the amount of change in the spray angle is less than zero, it means that the spray angle is reduced after the injection experiment. In FIG. 4, the spray angle is indicated as the example of the injection characteristic. However, the characteristic of the injection is not limited to the spray angle and can be any other indicative value, for example, an injection quantity of fuel or a width of the fuel spray.

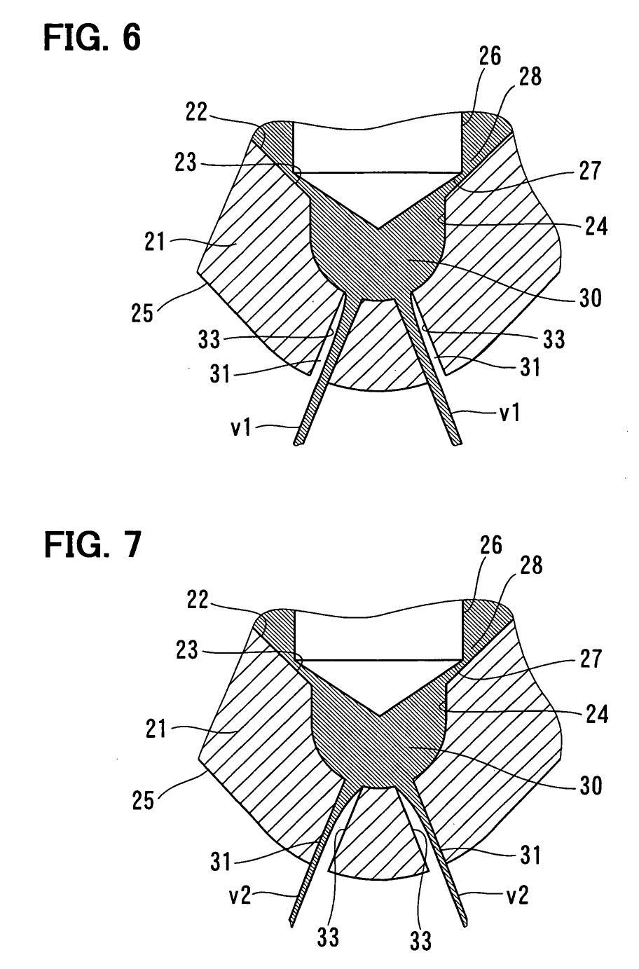

As shown in FIG. 4, when the value of A/2B is less than 1, the spray angle of fuel after the end of the experiment is increased in comparison to the beginning of the experiment. It means that when the value of A/2B is less than 1, the fuel flow (more specifically, an outer peripheral part of the fuel flow), which flows through the injection hole 31, is spaced away from the inner wall surface 33 of the valve body 21, which forms the injection hole 31. Thus, as shown in FIG. 6, a space or gap is formed between the wall surface 33 of the valve body 21, which forms the injection hole 31, and the fuel (fuel flow) v1, which passes through the injection hole 31. The space is formed at one lateral side (a radially outer side) of each injection hole 31, which is remote from the central axis c. When the fuel injection from the injection hole 31 is repeated, the foreign substance, which adheres to the wall surface 33 adjacent to the space, is not removed by the flow of the fuel v1 and is accumulated on the wall surface 33.

When the foreign substance is accumulated on the wall surface 33, the gas, such as fuel vapor, which is present in the space, is drawn out of the injection hole 31 by the flow of the fuel v1: Therefore, in the injection hole 31, the pressure is decreased in the remote lateral side of the flow of the fuel v1, which is remote from the central axis c. Thus, the direction of the flow of fuel, which passes through the injection hole 31, is deflected toward the remote lateral side (the radially outer side) of the flow of fuel, which is remote from the central axis c and has the reduced pressure. As a result, as shown in FIG. 4, when the value of A/2B is less than 1, the repeated fuel injections cause an increase in the spray angle.

In contrast, as shown in FIG. 4, when the value of A/2B becomes greater than 20, the spray angle of fuel after the end of the experiment is reduced in comparison to the beginning of the experiment. Like in the above case where the value of A/2B is less than 1, when the value of A/2B is greater than 20, the fuel, which flows through the injection hole 31, is spaced away from the inner wall of the valve body 21, which forms the injection hole 31. Thus, as shown in FIG. 7, a space or gap is formed between the wall surface 33 of the valve body 21, which forms the injection hole 31, and the fuel (fuel flow) v2, which passes through the injection hole 31. The space is formed at one lateral side (a radially inner side) of each injection hole 31, which is closer to the central axis c. When the fuel injection from the injection hole 31 is repeated, the foreign substance, which adheres to the wall surface 33 adjacent to the space, is not removed by the flow of the fuel v2 and is accumulated on the wall surface 33.

When the foreign substance is accumulated on the wall surface 33, the gas, which is present in the space is drawn out of the injection hole 31 by the flow of the fuel v2 in the injection hole 31. Therefore, in the injection hole 31, the pressure is decreased in the close lateral side (the radially inner side) of the flow of the fuel v2, which is close to the central axis c. Thus, the direction of the flow of fuel v2, which passes through the injection hole 31, is deflected toward the close lateral side (the radially inner side) of the flow of fuel v2, which is close to the central axis c and has the reduced pressure. As a result, as shown in FIG. 4, when the value of A/2B becomes greater than 20, the repeated fuel injections cause a decrease in the spray angle.

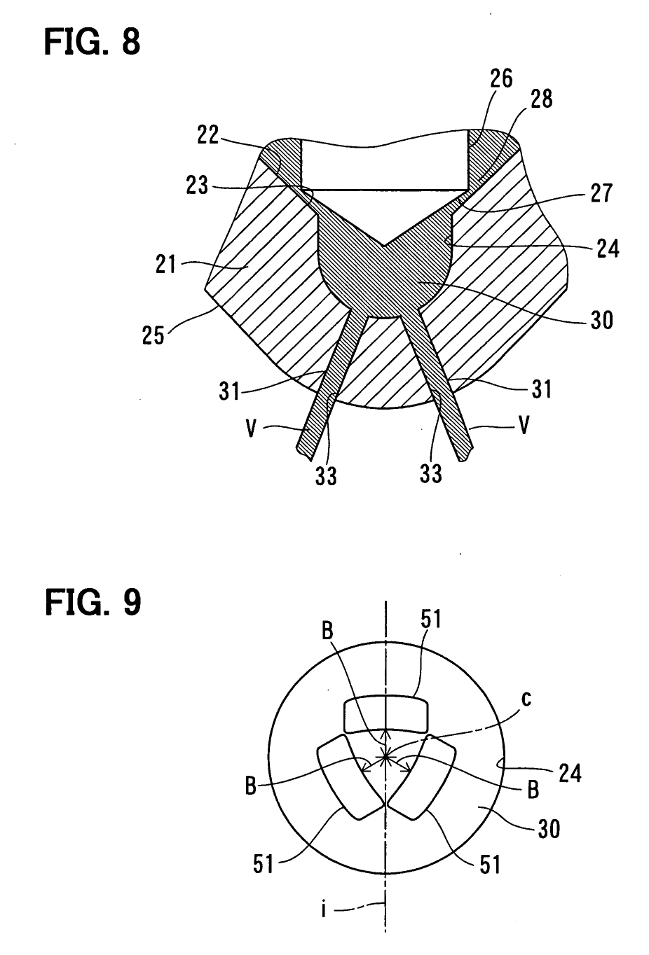

As shown in FIG. 4, when the value of A/2B is in the range of 1≦A/2B≦20, the change between the spray angle of fuel at the time of beginning of the experiment and the spray angle of fuel after the end of the experiment becomes relatively small. In the range of 1≦A/2B≦20, as shown in FIG. 8, the fuel V, which flows through the injection hole 31, is not spaced away from the wall surface 33 of the valve body 21, which forms the injection hole 31. Therefore, the space is not formed between the wall surface 33 of the valve body 21, which forms the injection hole 31, and the fuel (fuel flow) V, which passes through the injection hole 31. In this way, even when the fuel injection from the injection hole 31 is repeated, it is possible to limit adhesion of the foreign substance to the wall surface 33, which forms the injection hole 31. Also, even when the foreign substance is adhered to the wall surface 33, the foreign substance can be removed by the flow of the fuel V. As a result, as shown in FIG. 4, as long as the value of A/2B is kept in the range of 1≦A/2B≦20, the change in the spray angle is relatively small even if the fuel injection is repeated.

Next, an operation of the injector 10, which has the above structure, will be described.

When the coil 42 of FIG. 2 is not energized, the magnetic attractive force is not generated between the stationary core 43 and the movable core 44. Therefore, the movable core 44 is urged by the urging force of the spring 18 toward the downstream side, which is opposite from the stationary core 43. Thus, when the coil 42 is not energized, the sealing part 27 of the needle 26 is seated against the valve seat 23. As a result, fuel is not injected from the injection holes 31.

In contrast, when the coil 42 is energized, the magnetic field generated by the coil 42 causes formation of a magnetic circuit in the plate housing 45, the holder 20, the first magnetic part 12, the movable core 44, the stationary core 43 and the second magnetic part 14 to form a flow of magnetic flux. In this way, the magnetic attractive force is generated between the stationary core 43 and the movable core 44. When the magnetic attractive force, which is generated between the stationary core 43 and the movable core 44, becomes greater than the urging force of the spring 18, the movable core 44 and the needle 26, which are integrated together, are moved toward the stationary core 43. Therefore, the sealing part 27 of the needle 26 is lifted away from the valve seat 23.

The fuel, which is supplied from the fuel inlet 16, flows into the fuel passage 28 through the filter member 17, an interior of the inlet member 15, an interior of the adjusting pipe 19, an interior of the movable core 44, a fuel hole 49 and an interior of the holder 20. Here, the fuel hole 49 penetrates through the movable core 44 from a radially inner part to a radially outer part of the movable core 44. The fuel, which flows into fuel passage 28, is supplied into the injection holes 31 through the space between the valve body 21 and the needle 26 lifted away from the valve seat 23 and then through the sac volume 30. As a result, the fuel is injected through the injection holes 31.

When the energization of the coil 42 is stopped, the magnetic attractive force between the stationary core 43 and the movable core 44 no longer exists. In this way, the movable core 44 and the needle 26, which are formed integrally, are moved by the urging force of the spring 18 toward the downstream side, which is opposite from the stationary core 43. Therefore, the movable core 44 and the needle 26, which are formed integrally, are seated against the valve seat 23 by the urging force of the spring 18. As a result, the fuel flow between the fuel passage 28 and the injection holes 31 is blocked. Therefore, the fuel injection from the injection holes 31 is terminated.

As discussed above, in the first embodiment, the relationship between the inner diameter A of the sac volume 30 and the distance B from the central axis c of the sac volume 30 to each injection hole 31 is set to satisfy the condition of 1≦A/2B≦20. In this way, the fuel, which is supplied from the sac volume 30 into each injection hole 31 is not spaced away from the wall surface 33 of the valve body 21, which forms the injection hole 31, so that the fuel is effectively injected through the injection hole 31. Therefore, it is possible to limit the adhesion of the foreign substance to the wall surface 33, which forms the injection hole 31. Furthermore, even if the foreign substance is adhered to the wall surface 33, the foreign substance can be removed by the fuel, which flows through the injection hole 31. As a result, even when the fuel injection is repeated, the injection characteristic of fuel injected from the injection hole 31 may not be changed by the foreign substance, which is adhered to the wall surface 33. Therefore, the change in the injection characteristic with time caused by the fuel injections can be reduced.

In the first embodiment, the two injection holes 31 are arranged symmetrically about the imaginary straight line i, which serves as the symmetry axis. In this way, the fuel is uniformly supplied from the sac volume 30 into the two injection holes 31. Therefore, the fuel may not be spaced away from the wall surface 33, which forms the injection hole 31, and thereby the fuel can be effectively injected through the injection hole 31. As a result, it is possible to reduce the adhesion and accumulation of the foreign substance on the wall surface 33, which forms the injection hole 31. Therefore, the change in the injection characteristic with time caused by the fuel injections can be reduced.

### Second Embodiment

FIG. 9 shows positions of injection holes of an injector according to a second embodiment of the present invention. Components similar to those of the first embodiment will be indicated by the same numerals and will not be described further.

In the second embodiment, as shown in FIG. 9, the valve body 21 includes three injection holes 51. The three injection holes 51 are arranged three sides, respectively, of a generally equilateral triangular figure. In this way, the three injection holes 51 are uniformly arranged about the central axis of the sac volume 30. When the three injection holes 51 are uniformly arranged around the central axis c, the distance from the central axis c to each injection hole 51 becomes generally the same, i.e., constant. In addition, the three injection holes 51 are formed to have generally an identical shape. Furthermore, the three injection holes 51 are arranged symmetrically about an imaginary straight line i, which serves as a symmetry axis and crosses the central axis c in a direction perpendicular to the central axis c.

In the second embodiment, even in the case of positioning the three injection holes 51, each injection hole 51 is uniformly arranged about the central axis c. In this way, the fuel is uniformly supplied from the sac volume 30 into the three injection holes 51. Therefore, the fuel is not spaced away from the wall surface 33, which forms the injection hole 51, and therefore the fuel is effectively injected through each injection hole 51. As a result, it is possible to reduce the adhesion and accumulation of the foreign substance on the wall surface 33, which forms the injection hole 51. Therefore, the change in the injection characteristic with time caused by the fuel injections can be reduced.

In the above embodiments, the two injection holes 31 or the three injection holes 51 are provided in the valve body 21. However, the number of the injection holes is not limited to two or three and can be equal to or greater than four. Furthermore, in the above embodiments, each injection hole 31 or 51 is shaped into the slit. However, the shape of each injection hole 31, 51 may be a cylindrical form or a truncated cone form.

Additional advantages and modifications will readily occur to those skilled in the art. The invention in its broader terms is therefore not limited to the specific details, representative apparatus, and illustrative examples shown and described.

What is claimed is:

1. A fuel injection valve comprising:
a valve body that includes:
a valve seat that is formed in an inner wall surface of the valve body, which forms a fuel passage;
a sac volume that is arranged on a downstream side of the valve seat in a fuel flow direction; and
at least one injection hole that has an upstream end, which opens to the sac volume, and a downstream end, which opens to an outer wall surface of the valve body; and
a valve member that opens and closes the fuel passage when the valve member is lifted away from the valve seat and is seated against the valve seat, respectively, wherein the sac volume and each injection hole satisfy a condition of 1≦A/2B≦20 where A is an inner diameter of the sac volume, and B is a distance from a central axis of the sac volume to the injection hole at the upstream end of the injection hole.

2. The fuel injection valve according to claim 1, wherein each injection hole is formed as a slit.

3. The fuel injection valve according to claim 1, wherein the at least one injection hole of the valve body includes two or more injection holes.

4. The fuel injection valve according to claim 3, wherein the two or more injection holes are uniformly arranged about the central axis of the sac volume.
